(19) United States
(12) Patent Application Publication
(10) Pub. No.: US 2026/0084281 A1
(43) Pub. Date: Mar. 26, 2026

(54) Screw Turning Device

(71) Applicant: JOININ GLOBAL PTE.LTD., SG (SG)

(72) Inventor: Hongbing ZHENG, Hangzhou (CN)

(73) Assignee: JOININ GLOBAL PTE.LTD., SG (SG)

(21) Appl. No.: 18/893,929

(22) Filed: Sep. 23, 2024

(51) Int. Cl. B25G 1/04; B25B 23/10

(52) U.S. Cl. CPC B25G 1/043; B25B 23/105

(57) ABSTRACT

A screw turning device, comprising a screw turning mechanism and an extension mechanism. The screw turning mechanism is provided with one or more accommodating grooves and one or more limiting structures. The accommodating grooves and the limiting structures cooperate to allow a screw to be seized within the screw turning mechanism. The screw turning mechanism and the extension mechanism cooperate to realize screw-tightening operations from the ground to high altitudes. The screw turning mechanism is used to secure the screws that need to be installed. By coordinating the extension mechanism with the screw turning mechanism, it can perform high-altitude screw-tightening operations from the ground, making the process convenient, quick, and safe.

### FIELD OF TECHNOLOGY

The present disclosure belongs to the technical field of mechanic, and particularly relates to a screw turning device.

### BACKGROUND

Currently, in lamps, electronics, machinery and many other manufacturing industries, the combination and fixation between the workpieces are usually completed by tightening screws. Therefore, the screws play an indispensable role in daily life and industry, and are widely used in various fields.

High-altitude screw tightening is also a common task. Traditionally, staff climb ladders and use tools to tighten screws. When screws need to be tightened in multiple locations, workers usually need to move the ladder frequently and climb up and down repeatedly, which is dangerous and cumbersome.

### SUMMARY

The present disclosure provides a screw turning device, which addresses the dangers and cumbersome of traditional high-altitude screw-tightening methods.

The present disclosure provides a screw turning device, comprising a screw turning mechanism and an extension mechanism. The screw turning mechanism is provided with one or more accommodating grooves and one or more limiting structures, and the accommodating grooves and the limiting structures cooperate to allow a screw to be seized within the screw turning mechanism. The screw turning mechanism and the extension mechanism cooperate to realize screw-tightening operations from the ground to high altitudes.

In one embodiment, the screw turning device is provided with at least two accommodating grooves, and the accommodating grooves are arranged at an angle.

In one embodiment, each of the accommodating grooves is provided with a limiting structure, and the limiting structure matches a nut of the screw, to allow the screw to be seized within a corresponding accommodating groove.

In one embodiment, each of the accommodating grooves is provided with at least two limiting structures, and the limiting structures match the nut of the screw, to allow the screw to be seized within a corresponding accommodating groove.

In one embodiment, the limiting structure is disposed at a top of the corresponding accommodating groove.

In one embodiment, the limiting structure is disposed at a sidewall of the corresponding accommodating groove.

In one embodiment, the limiting structure is arranged in a stepped manner.

In one embodiment, each of the accommodating grooves comprises a first limiting surface, a second limiting surface and a third limiting surface. The first limiting surface and the second limiting surface are distributed opposite each other. The third limiting surface is coupled to the first limiting surface and the second limiting surface, respectively.

In one embodiment, the accommodating groove has a concave cavity, and a depth of the concave cavity matches that of a part of the screw below a nut.

In one embodiment, the third limiting surface has an arc structure, a structure of the third limiting surface matches that of a bottom curvature of the screw.

In one embodiment, the screw turning mechanism is provided with at least one suspension structure, and the suspension structure has a concave structure.

In one embodiment, the suspension structure is disposed at an extension part of the screw turning mechanism.

In one embodiment, at least two suspension structures are disposed at the same extension part of the screw turning mechanism.

In one embodiment, at least two suspension structures are disposed at different extension parts of the screw turning mechanism, respectively.

In one embodiment, the extension mechanism is detachably fixed to the screw turning mechanism by riveting, threading, snap-fitting, gluing, and/or interference fitting.

In one embodiment, the extension mechanism is fixedly connected to the screw turning mechanism.

In one embodiment, the extension mechanism and the screw turning mechanism are made of plastic and/or metal.

In one embodiment, the extension mechanism is a multi-section link rod and/or a one-piece rod.

In one embodiment, the extension mechanism is extended by a multi-section threaded link, a multi-section snap-fit link, and/or a multi-section plastic element link.

As described above, the screw turning device of the present disclosure has following beneficial effects.

In the present disclosure, the screw turning mechanism is used to secure the screws that need to be installed. By coordinating the extension mechanism with the screw turning mechanism, it can perform high-altitude screw-tightening operations from the ground, making the process convenient, quick, and safe.

By incorporating multiple accommodating grooves and limiting structures, this design ensures compatibility with various screw sizes, providing strong versatility.

The first limiting surface, second limiting surface, and third limiting surface of each accommodating groove restrict the left-right and front-back movement of the screw, so that the screw can be better fixed in the accommodating groove, enabling faster and more efficient screw-tightening operations from the ground to high altitudes.

The adjustable extension mechanism allows for screw-tightening operations at different heights, making the process convenient, quick, and safe.

The suspension structure disposed at the screw turning mechanism allows for easy suspension of desired items, achieving multifunctionality, convenience, and versatility.

### BRIEF DESCRIPTION OF THE DRAWINGS

FIG. 1 is a schematic diagram of a screw turning device according to an embodiment of the present disclosure.

FIG. 2 is a schematic diagram of a screw turning mechanism according to an embodiment of the present disclosure.

FIG. 3 is a front view of the screw turning mechanism according to the embodiment of the present disclosure.

FIG. 4 is a schematic diagram showing the cross-sectional structure at A-A in FIG. 3.

FIG. 5 is a schematic diagram showing the cross-sectional structure at B-B in FIG. 3.

FIG. 6 is a front view of the screw turning mechanism with a screw installed therein.

FIG. 7 is a schematic diagram showing the cross-sectional structure at A-A in FIG. 6.

Reference Numerals

| | |
|---|---|
| 1 | Screw Turning Device |
| 11 | Screw Turning Mechanism |
| 111, 111a, 111b | Accommodating Groove |
| 1111, 1111a, 1111b | First Limiting Surface |
| 1112, 1112a, 1112b | Second Limiting Surface |
| 1113 | Third Limiting Surface |
| 112, 112a, 112b | Limiting Structure |
| 113 | Suspension Structure |
| 114 | Extension Part |
| 12 | Extension Mechanism |
| 2 | Screw |
| 21 | Nut |

### DETAILED DESCRIPTION

The embodiments of the present disclosure will be described below. Those skilled can easily understand other advantages and effects of the present disclosure according to contents disclosed by the specification. The present disclosure can also be implemented or applied through other different specific embodiments. Various modifications or changes can also be made to all details in the specification based on different viewpoints and applications without departing from the spirit of the present disclosure. It needs to be stated that the following embodiments and the features in the embodiments can be combined with one another if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation. During the actual implementation, the type, quantity and proportion of each component can be changed as needed, and the layout of the components can also be more complicated.

The following embodiments provide a screw turning device, which addresses the dangers and cumbersome of traditional high-altitude screw-tightening methods.

The principles and implementations of the screw turning device of the present embodiment will be described in detail below in conjunction with the accompanying drawings, so that those skilled in the art can understand the screw turning device of the present embodiment without creative labor.

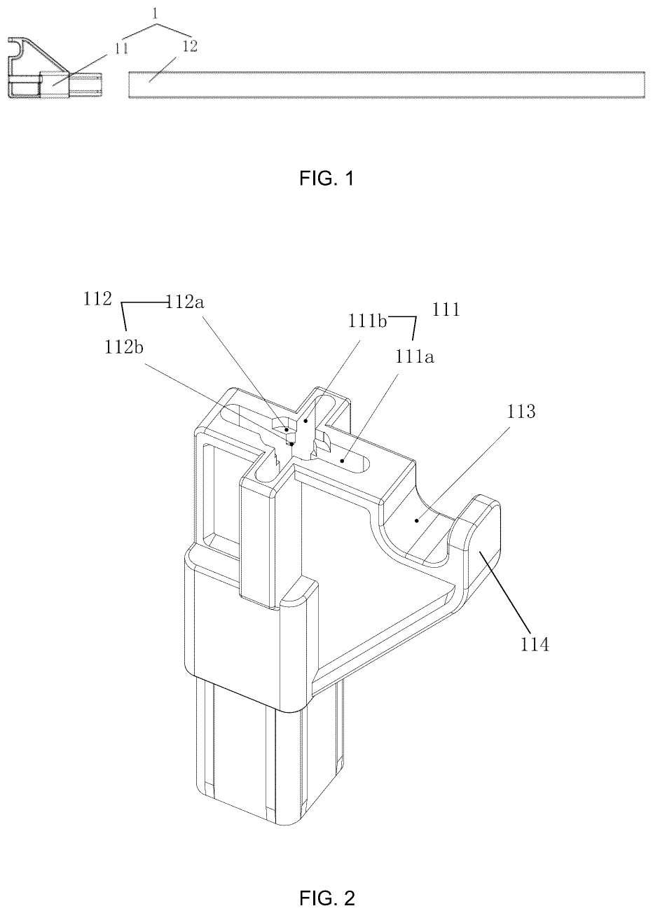

As shown in FIGS. 1 and 2, the present disclosure provides a screw turning device 1, comprising a screw turning mechanism 11 and an extension mechanism 12.

The screw turning mechanism 11 is provided with one or more accommodating grooves 111 and one or more limiting structures 112. The accommodating grooves 111 and the limiting structures 112 cooperate to allow a screw 2 to be seized within the screw turning mechanism 11.

The screw turning mechanism 11 and the extension mechanism 12 cooperate to realize screw-tightening operations from the ground to high altitudes.

Specifically, each of the accommodating grooves 111 is a screw groove with a concave cavity for placing the part of the screw 2 below a nut 21, each of the limiting structure 112s is configured to contact the nut of the screw, and the accommodating grooves 111 and the limiting structures 112 cooperate to allow the screw 2 to be seized in the screw turning mechanism 11. The structure and dimensions of the limiting structures match those of the corresponding nut to be contacted.

In one embodiment, the limiting structures 112 are disposed at a middle part of a top of the accommodating grooves and are arranged in a stepped manner. The structure and dimensions of the limiting structures match those of the corresponding nut to be contacted.

It is noted that the number and structure of the accommodating grooves 111 and the limiting structures 112 can be adjusted as needed.

In the present disclosure, the screw turning mechanism 1 is used to secure the screw 2 that needs to be installed. By coordinating the extension mechanism 12 with the screw turning mechanism 11, it can perform high-altitude screw-tightening operations from the ground, making the process convenient, quick, and safe.

In an embodiment of the present disclosure, the screw turning mechanism 11 is provided with at least two accommodating grooves 111, and the accommodating grooves 111 are arranged at an angle.

Specifically, as shown in FIG. 2, the screw turning mechanism 11 comprises an accommodating groove 111a and an accommodating groove 111b, and the accommodating grooves 111a and 111b are arranged at an angle.

In one embodiment, the accommodating groove 111b is positioned vertically relative to the accommodating groove 111a.

The screw turning mechanism 11 of the present disclosure can comprise several different accommodating grooves 111, which can vary in shape and position. These accommodating grooves 111 are arranged at an angle, allowing compatibility with screws of different sizes.

It is to be noted that the number, structure and position of the accommodating grooves 111 can be adjusted according to actual needs.

In an embodiment of the present disclosure, each of the accommodating grooves 111 is provided with a limiting structure 112. The limiting structure 112 matches the nut 21 of the screw 2 to allow the screw 2 to be seized within the corresponding accommodating groove 111.

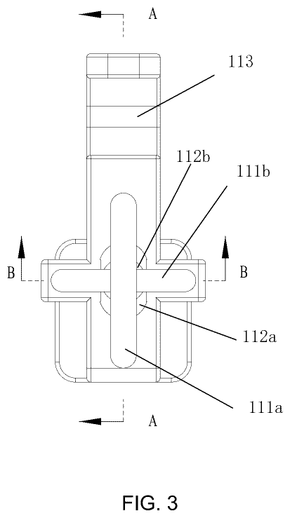

Specifically, FIG. 3 shows a front view of the screw turning mechanism according to an embodiment of the present disclosure. As shown in FIG. 3, the accommodating grooves 111a and 111b are respectively provided with the limit structures 112a and 112b, the limit structures 112 (112a and 112b) are in contact with the nut of the screw, the accommodating grooves 111 (111a and 111b) are used for placing the part of the screw below the nut, and the accommodating grooves 111 and the limiting structures 112 cooperate to allow the screw 2 to be seized within the screw turning mechanism 11. The structure and dimensions of the limiting structures match those of the corresponding nut to be contacted.

In one embodiment, each of the accommodating grooves 111 is provided with at least one limiting structure 112, and the limiting structure 112 can be disposed at different positions of the accommodating groove 111, allowing for compatibility with different-sized screws.

In one embodiment, the limiting structures 112 are disposed at the middle part of the accommodating groove and are arranged in a stepped manner. The structure and dimensions of the limiting structure match those of the corresponding nut to be contacted.

It is to be noted that the number and structure of the accommodating grooves 111 and the limiting structures 112 can be adjusted as needed, and one accommodating groove 111 may comprise several limiting structures 112.

In an embodiment of the present disclosure, each of the accommodating grooves 111 is provided with at least two limiting structures 112, one limiting structure 112 matches the nut 21 of the screw 2 to allow the screw 2 to be seized within the corresponding accommodating groove 111.

Specifically, each of the accommodating grooves 111 can be provided with at least two limiting structures 112, and the limiting structures 112 are disposed at different positions of the corresponding accommodating groove 111, allowing the screw turning mechanism 11 to accommodate screws of various shapes, enabling a single screw turning device to handle high-altitude installation tasks for screws of different specifications, offering great versatility.

In an embodiment of the present disclosure, the limiting structures 112 are provided at the top of the corresponding accommodating groove 111.

In an embodiment of the present disclosure, the limiting structures 112 are provided on a sidewall of the corresponding accommodating groove 111.

Specifically, the limiting structures 112 can be located at the top of the accommodating groove 111, such as the middle part or both ends of the top of the accommodating groove 111, or it can be located at the sidewall of the accommodating groove 111. Each of the limiting structures 112 needs to match at least one nut, so that the screw can be seized within the corresponding accommodating groove, allowing for the installation of screws of various sizes at high altitudes.

In an embodiment of the present disclosure, the limiting structures 112 are arranged in a stepped manner, with their size matching that of the nut of the corresponding screw.

In an embodiment of the present disclosure, each of the accommodating grooves 111 comprises a first limiting surface 1111 (not depictured), a second limiting surface 1112 (not depictured) and a third limiting surface 1113. The first limiting surface 1111 and the second limiting surface 1112 are distributed opposite each other, the third limiting surface 1113 is coupled to the first limiting surface 1111 and the second limiting surface 1112, respectively.

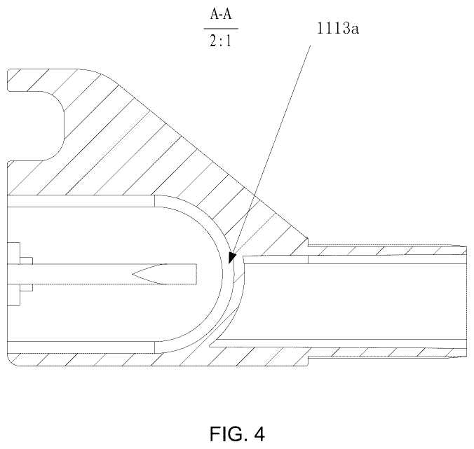

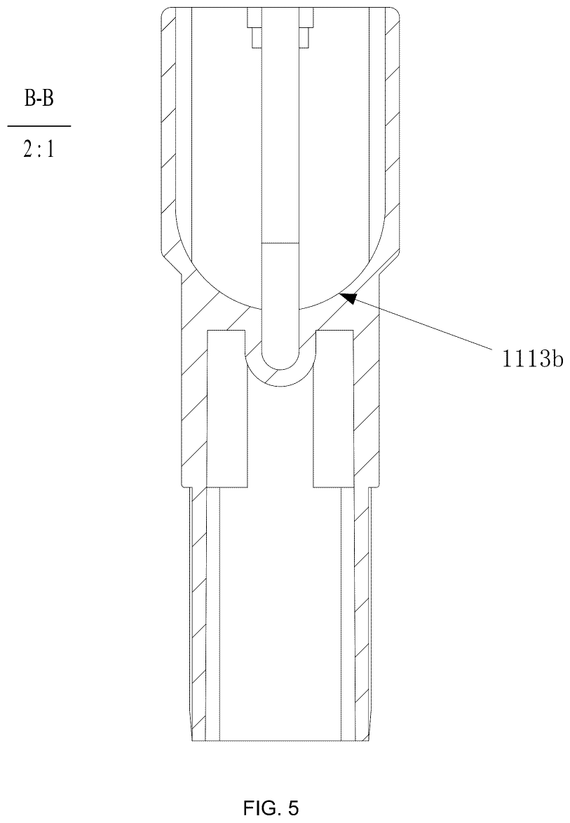

Specifically, FIG. 3 shows a front view of the screw turning mechanism according to an embodiment of the present disclosure, FIG. 4 is a schematic diagram showing the cross-sectional structure at A-A in FIG. 3, and FIG. 5 is a schematic diagram showing the cross-sectional structure at B-B in FIG. 3. As shown in FIGS. 3 to 5, the accommodating groove 111a comprises a first limiting surface 1111a, a second limiting surface 1112a (i.e. left and right limiting surfaces, both of which are not depictured), and a third limiting surface 1113a (i.e. bottom curvature limiting surface, cf. FIG. 4). The first limiting surface 1111a and the second limiting surface 1112a are distributed opposite each other, the third limiting surface 1113a is coupled to the first limiting surface 1111a and the second limiting surface 1112a, respectively, the screw is placed in the accommodating groove 111a. By utilizing the first limiting surface 1111a, the second limiting surface 1112a, and the third limiting surface 1113a, the screw turning device of the present disclosure can effectively prevent the screw from moving left, right, forward, or backward, ensuring it is securely fixed in place.

To further prevent the screw from moving back and forth, the middle part of the accommodating groove 111a is provided with the limiting structure 112, which is in contact with the nut of the screw. The accommodating groove 111a has a concave cavity, which has enough depth to cover the screw curvature and the part below the nut, so that the screw can be securely fixed in the screw turning mechanism 11, allowing faster and more efficient screw-tightening operations at high altitudes.

The accommodating groove 111b comprises a first limiting surface 1111b, a second limiting surface 1112b (i.e. left and right limiting surfaces, both of which are not depictured), and a third limiting surface 1113b (i.e. bottom curvature limiting surface, cf. FIG. 5). The first limiting surface 1111b and the second limiting surface 1112b are distributed opposite each other, the third limiting surface 1113b is coupled to the first limiting surface 1111b and the second limiting surface 1112b, respectively, the screw is placed in the accommodating groove 111b. By utilizing the first limiting surface 1111b, the second limiting surface 1112b, and the third limiting surface 1113b, the screw turning device of the present disclosure can effectively prevent the screw from moving left, right, forward, or backward, ensuring it is securely fixed in place.

To further prevent the screw from moving back and forth, the middle part of the accommodating groove 111b is provided with the limiting structure 112, which is in contact with the nut of the screw. The accommodating groove 111b has a concave cavity, which has enough depth to cover the screw curvature and the part below the nut, so that the screw can be securely fixed in the screw turning mechanism 11, allowing faster and more efficient screw-tightening operations at high altitudes.

In an embodiment of the present disclosure, each of the accommodating grooves 111 has a concave cavity, and the depth of the concave cavity matches that of the part of the screw below the nut.

Specifically, the depth of the concave cavity can cover the part of the screw below the nut and the bottom curvature of the screw.

In an embodiment of the present disclosure, the third limiting surface 1113 has an arc structure, to match the bottom curvature of the screw.

Specifically, the structure of the third limiting surface 1113 matches that of the bottom curvature of the screw, ensuring a more secure fixation of the screw.

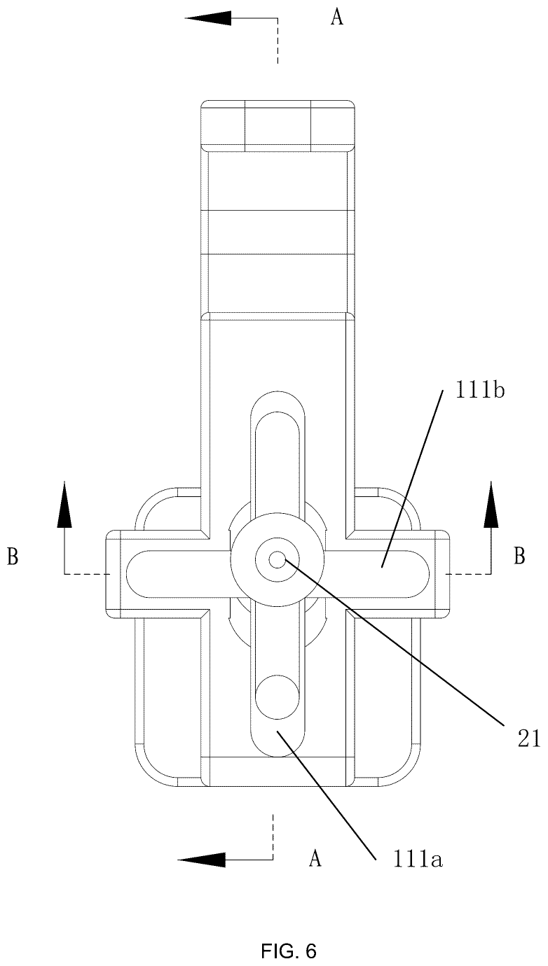

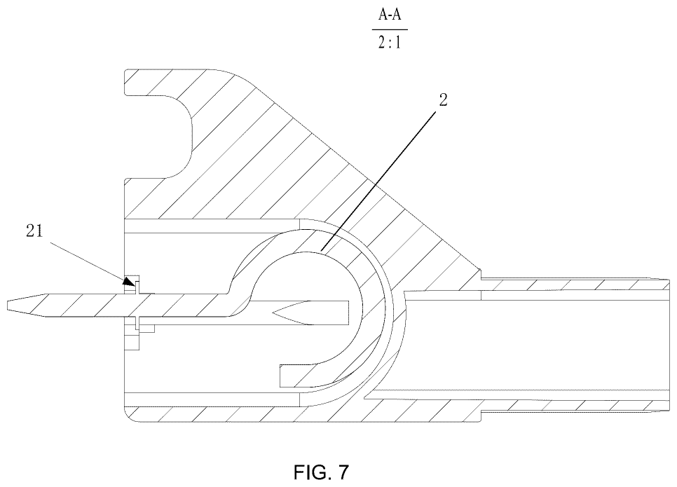

FIG. 6 is a front view of the screw turning mechanism with a screw installed therein, and FIG. 7 is a schematic diagram showing the cross-sectional structure at A-A in FIG. 6. As shown in FIGS. 6 and 7, the screw 2 is placed in the accommodating grooves 111, the nut 21 of the screw 2 is in contact with the corresponding limiting structure. Each of the accommodating grooves 111 has a concave cavity, and the depth of the concave cavity can cover the part of the screw below the nut and the bottom curvature of the screw. The third limiting surface 1113 has an arc structure, to match the bottom curvature of the screw, ensuring a more secure fixation of the screw.

In an embodiment of the present disclosure, the screw turning mechanism 11 is provided with a suspension structure 113, and the suspension structure 113 has a concave structure.

In an embodiment of the present disclosure, the suspension structure 113 is disposed at an extension part 114 of the screw turning mechanism 11.

Specifically, the screw turning mechanism 11 is provided with the suspension structure 113 disposed on the extension part 114, and the extension part 114 is located on one side of the screw turning mechanism 11. After fixing the screw at a high position, users can easily use the suspension structure 113 to hang items on a hook of the screw at a high place.

In an embodiment of the present disclosure, at least two suspension structures are disposed on the same extension part of the screw turning mechanism.

Specifically, the screw turning mechanism is provided with an extension part, and the extension part is provided with at least two suspension structures, allowing multiple items to be hung simultaneously.

In an embodiment of the present disclosure, at least two suspension structures are disposed on the different extension parts of the screw turning mechanism.

Specifically, the screw turning mechanism can comprise at least two extension parts, and each of the extension parts is provided with a suspension structure.

It is noted that the location, shape, size and number of suspension structures are not limited to the present disclosure.

In an embodiment of the present disclosure, the screw turning device 1 further comprises the extension mechanism 12, and the extension mechanism 12 and the screw turning mechanism 11 cooperate to realize screw-tightening operations from the ground to high altitudes.

Specifically, the extension mechanism 12 is an extension rod fixedly connected with a bottom of the screw turning mechanism 11, allowing for screw-tightening operations from the ground to high altitudes.

In an embodiment of the present disclosure, the extension mechanism 12 is detachably fixed to the screw turning mechanism 11 by riveting, threading, snap-fitting, gluing and/or interference fitting.

Specifically, the connection between the extension mechanism 12 and the screw turning mechanism 11 includes but is not limited to riveting, threading, snap-fitting, gluing and/or interference fitting, etc. They can be disassembled and packaged separately during packaging and transportation, reducing the transportation volume. After receiving the components, users can directly assemble and use them. If any component of the extension mechanism 12 or the screw turning mechanism 11 is damaged, the damaged component can be replaced without replacing the whole mechanism, saving user costs.

In an embodiment of the present disclosure, the extension mechanism 12 is fixedly connected to the screw turning mechanism 11.

It is to be noted that the connection between the extension mechanism 12 and the screw turning mechanism 11 can be set according to the actual needs. In another embodiment, the extension mechanism 12 and the screw turning mechanism 11 can also be welded together, eliminating the need for assembly during use.

In an embodiment of the present disclosure, the extension mechanism 12 is a multi-section threaded link rod, a multi-section snap-fit link rod, a multi-section plastic element link rod, and/or a one-piece rod.

In one embodiment, the extension mechanism 12 is a multi-section threaded link, a multi-section snap-fit link, and/or a multi-section plastic element link. The length of the extension mechanism 12 can be extended according to the user's needs, allowing for screw-tightening at different heights from the ground.

In another embodiment, the extension mechanism 12 may also be a one-piece rod. In this way, allowing for screw-tightening at a fixed height from the ground.

In an embodiment of the present disclosure, the extension mechanism 12 achieves extension through the multi-section threaded link, multi-section snap-fit link, and/or plastic link.

In an embodiment of the present disclosure, the extension mechanism 12 and the screw turning mechanism 11 are made of plastic and/or metal, respectively.

The installation process of the screw turning device of the present disclosure is as follows: a suitable accommodating groove and a suitable limiting structure are first selected according to the size of the screw to be fixed, the screw is then placed in the suitable accommodating groove, and the nut of the screw is in contact with the corresponding limiting structure of the accommodating groove, to limit the movement of the screw. The first (left) limiting surface, the second (right) limiting surface and the third (bottom curvature) limiting surface of the accommodating groove can further prevent the screw from moving left, right, up, or down. By adjusting the height range of the extension mechanism and turning the screw in the corresponding high position, it can realize screw-tightening operations from the ground to high altitudes.

Meanwhile, after the screw is fixed, the suspension structure of the screw turning mechanism can be used to hang items on the hook of the screw at a high place, which is convenient, safe and efficient, providing a better user experience.

As described above, the screw turning device of the present disclosure has following beneficial effects.

In the present disclosure, the screw turning mechanism is used to secure the screws that need to be installed. By coordinating the extension mechanism with the screw turning mechanism, it can perform high-altitude screw-tightening operations from the ground, making the process convenient, quick, and safe.

By incorporating multiple accommodating grooves and limiting structures, this design ensures compatibility with various screw sizes, providing strong versatility.

The first limiting surface, second limiting surface, and third limiting surface of each accommodating groove restrict the left-right and front-back movement of the screw, so that the screw can be better fixed in the accommodating groove, enabling faster and more efficient screw-tightening operations from the ground to high altitudes.

The adjustable extension mechanism allows for screw-tightening operations at different heights, making the process convenient, quick, and safe.

The suspension structure disposed at the screw turning mechanism allows for easy suspension of desired items, achieving multifunctionality, convenience, and versatility.

The descriptions of the processes or structures corresponding to each of the above accompanying drawings have their own focuses, and the parts that are not described in detail in a certain process or structure can be found in the relevant descriptions of other processes or structures.

The above-mentioned embodiments are merely illustrative of the principle and effects of the present disclosure instead of limiting the present disclosure. Modifications or variations of the above-described embodiments may be made by those skilled in the art without departing from the spirit and scope of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A screw turning device, comprising a screw turning mechanism and an extension mechanism;
wherein the screw turning mechanism is provided with one or more accommodating grooves and one or more limiting structures, and the accommodating grooves and the limiting structures cooperate to allow a screw to be seized within the screw turning mechanism;
wherein the screw turning mechanism and the extension mechanism cooperate to realize screw-tightening operations from the ground to high altitudes.

2. The screw turning device according to claim 1, wherein the screw turning device is provided with at least two accommodating grooves, and the accommodating grooves are arranged at an angle.

3. The screw turning device according to claim 2, wherein each of the accommodating grooves is provided with a limiting structure, and the limiting structure matches a nut of the screw, to allow the screw to be seized within a corresponding accommodating groove.

4. The screw turning device according to claim 2, wherein each of the accommodating grooves is provided with at least two limiting structures, and the limiting structures match the nut of the screw, to allow the screw to be seized within a corresponding accommodating groove.

5. The screw turning device according to claim 3 wherein the limiting structure is disposed at a top of the corresponding accommodating groove.

6. The screw turning device according to claim 3, wherein the limiting structure is disposed at a sidewall of the corresponding accommodating groove.

7. The screw turning device according to claim 5, wherein the limiting structure is arranged in a stepped manner.

8. The screw turning device according to claim 1, wherein each of the accommodating grooves comprises a first limiting surface, a second limiting surface and a third limiting surface; wherein the first limiting surface and the second limiting surface are distributed opposite each other; wherein the third limiting surface is coupled to the first limiting surface and the second limiting surface, respectively.

9. The screw turning device according to claim 8, wherein the accommodating groove has a concave cavity, and a depth of the concave cavity matches that of a part of the screw below a nut.

10. The screw turning device according to claim 8, wherein the third limiting surface has an arc structure; wherein a structure of the third limiting surface matches that of a bottom curvature of the screw.

11. The screw turning device according to claim 1, wherein the screw turning mechanism is provided with at least one suspension structure, and the suspension structure has a concave structure.

12. The screw turning device according to claim 11, wherein the suspension structure is disposed at an extension part of the screw turning mechanism.

13. The screw turning device according to claim 11, wherein at least two suspension structures are disposed at the same extension part of the screw turning mechanism.

14. The screw turning device according to claim 11, wherein at least two suspension structures are disposed at different extension parts of the screw turning mechanism, respectively.

15. The screw turning device according to claim 1, wherein the extension mechanism is detachably fixed to the screw turning mechanism by riveting, threading, snap-fitting, gluing, and/or interference fitting.

16. The screw turning device according to claim 1, wherein the extension mechanism is fixedly connected to the screw turning mechanism.

17. The screw turning device according to claim 1, wherein the extension mechanism is a multi-section link rod and/or a one-piece rod.

18. The screw turning device according to claim 1, wherein the extension mechanism is extended by a multi-section threaded link, a multi-section snap-fit link, and/or a multi-section plastic element link.

19. The screw turning device according to claim 1, wherein the extension mechanism and the screw turning mechanism are made of plastic and/or metal.
